(19) United States
(12) Patent Application Publication
(10) Pub. No.: US 2014/0268848 A1
(43) Pub. Date: Sep. 18, 2014

(54) HEADLAMP HAVING A LIGHT GUIDE ASSEMBLY

(71) Applicants: Thomas Tessnow, Weare, NH (US); Lawrence M. Rice, Hillsboro, NH (US); Ronald Boyd, Chichester, NH (US); Howard B. Eng, Hancock, NH (US)

(72) Inventors: Thomas Tessnow, Weare, NH (US); Lawrence M. Rice, Hillsboro, NH (US); Ronald Boyd, Chichester, NH (US); Howard B. Eng, Hancock, NH (US)

(73) Assignee: OSRAM SYLVANIA Inc., Danvers, MA (US)

(21) Appl. No.: 13/837,133

(22) Filed: Mar. 15, 2013

(51) Int. Cl. F21S 8/10

(52) U.S. Cl. CPC F21S 48/1241
USPC 362/511

(57) ABSTRACT

An automotive headlamp (10) having a solid-state light source (14) and a reflector (16) having a light collecting region (18) adapted to receive a first portion of light emitted by the solid-state light source (14) and reflect the first portion of light in a first illumination pattern. The automotive headlamp (10) further includes a light guide assembly (22) adapted to receive a second portion of light emitted by the solid-state light source (14) and redirect the second portion of light in a second illumination pattern.

### CROSS REFERENCE TO RELATED APPLICATIONS

N/A

### TECHNICAL FIELD

The present disclosure relates to lighting systems, and, more particularly, to an automotive headlamp having a light guide assembly.

### BACKGROUND

Lighting systems are well-known and are used in a wide variety of applications, including automotive applications. Generally, an automotive headlamp, for example, includes a light source and optical components, such as lenses and reflectors to collect and shape light emitted by the light source and to project the resulting beam pattern forward of the vehicle in a light distinct pattern.

The incorporation of solid-state light sources, such as light emitting diodes (LEDs) into headlamps has been a goal from some manufacturers in the lighting industry due to the many benefits provided by LEDs. Some current LED headlamp systems are either multiple source per beam (i.e. multiple LED sources) or single source per beam (i.e. single LED source) design. The multiple source design is generally expensive to manufacture and requires exact alignment between the multiple sources, thus making a multiple source design difficult to construct. The single source design is generally easier to build, but has some styling limitations similar to halogen or HID-based headlamps.

Generally, a single LED source headlamp will have either a reflector optic or a projector lens, or a combination of both. As generally understood, direct projector lenses (without a reflector) are thick, complex lenses. Projector lenses may be interesting for styling purposes, but may be difficult and expensive to manufacture. Headlamps incorporating reflector optics are generally inexpensive and relatively easy to manufacture, but resemble conventional halogen headlamps.

Although LEDs provide numerous benefits, direct viewing of an LED can be uncomfortable for a viewer. As such, manufacturers recognized that the light emitted from the LED needs to be needs to redirected to create a well spread, yet sufficiently directed or focused at the intended subject area (e.g. area in front of the vehicle in a low or high-beam pattern) and not directed into the eyes of oncoming traffic. Some current LED-based headlamps include a fixed glare baffle to block stray light emitted from the LED to avoid glare caused by the headlamp that may distract and blinding oncoming traffic. Some current headlamp systems further include specific components (other than typical reflector optics and project lenses) integrated into the headlamp for directing portions of light emitted by the light source in a desired pattern. For example, some headlamp systems include distributed lighting systems having optical waveguides, or light guides. Examples of such headlamp systems are found, for example, in U.S. Pat. No. 6,186,650 (Hulse); U.S. Pat. No. 6,637,921 (Coushaine); and U.S. Pat. No. 6,652,129 (Aoki).

### BRIEF DESCRIPTION OF THE DRAWINGS

Reference should be made to the following detailed description which should be read in conjunction with the following figures, wherein like numerals represent like parts:

FIG. 1 illustrates a perspective view of one embodiment of a headlamp consistent with the present disclosure;

FIGS. 2-4 illustrate top, front and side views of the headlamp of FIG. 1 consistent with various embodiments of the present disclosure;

FIG. 5 illustrates a perspective view of one embodiment of a light guide assembly of the headlamp of FIG. 1;

FIG. 6 illustrates a side view of the light guide assembly of FIG. 5;

FIGS. 7A and 7B illustrate enlarged side views of an embodiments of optic elements of the light guide assembly of FIG. 6;

FIG. 8A illustrates a top cross-sectional view of the headlamp of FIG. 1 in a low-beam mode;

FIG. 8B illustrates a side view of the headlamp of FIG. 3 in a low-beam mode;

FIG. 9 illustrates a perspective view of another embodiment of a light guide assembly of a headlamp consistent with the present disclosure;

FIG. 10 illustrates a perspective view of another embodiment of a light guide assembly of a headlamp consistent with the present disclosure; and

FIG. 11 illustrates a top view of the light guide assembly and headlamp of FIG. 10.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION

By way of an overview, one aspect consistent with the present disclosure may feature an automotive headlamp. The headlamp includes a solid-state light source (i.e. a single string of one or more LEDs) and a reflector having a light collecting region adapted to receive a first portion of light emitted by the solid-state light source and reflect the first portion of light in a first illumination pattern. Generally, the first portion of light is emitted by the solid-state light source in a direction towards the light collecting region of the reflector.

The headlamp further includes a light guide assembly adapted to receive a second portion of light emitted by the solid-state light source and redirect the second portion of light in a second illumination pattern. Generally, the second portion of light is emitted by the solid-state light source in a direction towards the first end of the light guide element. As generally understood, the second portion of light may include stray light, wherein, if allowed to emit from the headlamp, the stray light may result in glare that can distract and temporality affect the vision of oncoming drivers. The light guide assembly includes at least one light guide element including a body having a first end and a second end. The first end of the light guide element is positioned adjacent to the solid-state light source and adapted to collect the second portion of light and the body is adapted to transmit the collected second portion of light from the first end to the second end. The second end of the light guide element is adapted to redirect the collected second portion of light in the second illumination pattern to decrease the potential for glare.

In one embodiment, the first illumination pattern is a low-beam illumination pattern, in which visible light is generally reflected from the reflector and emitted from the headlamp below or at and below a horizontal plane and the second illumination pattern includes visible light redirected by the light guide assembly and emitted from the headlamp generally below the horizontal plane, thereby reducing the potential for glare. When light is directed below or at and below the horizontal plane, it is generally emitted in a direction directed below or at and below the horizon, which is a virtual plane located far ahead of the vehicle.

A light guide assembly consistent with the present disclosure is configured to improve the overall performance of a headlamp having a solid-state light source (e.g. LED). In particular, the light guide assembly replaces the conventional fixed glare baffle found in some current LED-based headlamps and, rather than completely blocking stray light (the general function of a fixed glare baffle), the light guide assembly is configured to collect stray light, including stray light emitted from the solid-state light source and/or stray light reflected by a reflector of the headlamp, and further redirect the stray light in a specific illumination pattern to reduce the potential for glare for oncoming drivers. The collection and redirection of stray light, that would otherwise be blocked by a fixed glare baffle, increases the overall collection efficiency of the headlamp and thereby improves overall performance and quality of light output of the headlamp. Additionally, the inclusion of the light guide assembly further allows a wider range of headlamp designs and styling that may distinguish such a headlamp from current headlamp designs.

Turning now to FIG. 1, a perspective view of one embodiment of an automotive headlamp 10 consistent with the present disclosure is generally illustrated. FIGS. 2-4 illustrate top, front and side views of the headlamp of FIG. 1 consistent with various embodiments of the present disclosure. In the illustrated embodiment, the automotive headlamp 10 includes a light engine 12 having a solid-state light source 12, wherein the solid-state light source 12 may include a light emitting diode (LED). While the light engine 12 is illustrated as having a single solid-state light source 14, such as a single LED, the light engine 12 may include multiple solid-state light sources depending on the application. For example, the light engine 12 may include a single string of multiple LEDs. The solid-state light source 14 may include a luminous flux of 1000 lumens (lm). In one embodiment, the light engine 12 may include a commercially available LED light source sold under the trade designation JOULE JFL2 available in the U.S. from OSRAM Sylvania.

The headlamp 10 further includes a reflector 16 having a light collecting region 18 having a reflective surface 20. As described in greater detail herein, the light collecting region 18 is adapted to receive a first portion of light emitted by the solid-state light source 14 and reflect the first portion of light in a first illumination pattern. As shown, the light collecting region 18 has a generally parabolic shape. It should be noted that the light collecting region 18 (and/or the reflector 16 in general) may include a variety of shapes and/or dimensions depending on desired light distribution.

As shown, the light engine 12 is positioned adjacent to the reflector 16. As generally understood by one skilled in the art, the light engine 12 may be side-mounted, or side-loaded, with respect to the reflector 16. The solid-state light source 14 is adapted to emit a first portion of light in a direction towards the reflective surface 20 of the light collecting region 18 of the reflector 16. In turn, the reflective surface 20 is configured to receive and reflect the first portion of light emitted by the solid-state light source 14 such that the headlamp 10 projects a first illumination pattern based on light reflected from the reflective surface 20 of the light collecting region 18.

The headlamp 10 further includes a light guide assembly 22 positioned adjacent to the light engine 12. The light guide assembly 22 includes at least one light guide element 24. The light guide element 24 includes a body 26 having a first end 28 and a second end 30 and is defined by two spaced surfaces 32, 34 extending from the first end 28 to the second end 30. In the illustrated embodiment, the first end 28 of the light guide element 24 is positioned adjacent to the solid-state light source 14. The solid-state light source 14 is adapted to emit a second portion of light in a direction towards the first end 28. In turn, the first end 28 of the light guide element 24 is adapted collect the second portion of light and the body 26 is further adapted to transmit the collected second portion of light from the first end 28 to the second end 30. The second end 30 of the light guide element 24 is adapted to redirect the collected second portion of light such that the headlamp 10 projects a second illumination pattern based on light redirected by the second end 30 of the light guide element.

As described in greater detail herein, the automotive headlamp 10 may further include a housing 56 and outer lens 58. However, the housing 56 and outer lens 58 are not shown in FIGS. 1-4 for purposes of clarity.

The following description is directed to one embodiment of the headlamp 10 in which the first illumination pattern is a low-beam illumination pattern. More specifically, the reflective surface 20 of the light collecting region 18 of the reflector 16 is configured to receive and reflect the first portion of light emitted by the solid-state light source 14 in a low-beam illumination pattern, such that visible light is emitted from headlamp 10 generally below or at and below a horizontal plane P_{H}. The second illumination pattern generally includes visible light redirected by the light guide assembly 22 and emitted from the headlamp 10 generally below the horizontal plane P_{H}.

In other embodiments, the first illumination pattern may be a high-beam illumination pattern, such that light reflected by the reflective surface 20 of the light collecting region 18 of the reflector 16 is emitted from the headlamp 10 generally above and below the horizontal plane P_{H}. In other embodiments, particularly in embodiments in which the reflector 16 is configured to reflect light in a high-beam illumination pattern, the second illumination pattern may continue to include visible light redirected by the light guide assembly 22 generally below the horizontal plane P_{H} or the second illumination pattern may include visible light redirected by the light guide assembly 22 and emitted from the headlamp 10 generally above the horizontal P_{H}.

Local laws and regulations governing vehicle standards, such as Federal Motor Vehicle Safety Standards (FMVSS) and Regulations, may include specific regulations regarding the placement of low-beam and or high-beam projecting portions of the headlamp. As such, depending on the region-specific laws and regulations, the mounting orientation of the headlamp 10 may vary in order to comply with such laws and regulations. For example, the headlamp 10 may be mounted in the chassis of a vehicle such that a horizontal plane P_{H}, extending through the reflector 16 and the body 26 of the light guide element 24, is substantially parallel to a horizontal plane (not shown) along a length of the vehicle. As generally understood, the headlamp 10 may be mounted in different orientations.

FIGS. 5 and 6 illustrate perspective and side views of one embodiment of a light guide assembly 22 of the headlamp 10 of FIG. 1. In the illustrated embodiment, the light guide assembly 22 includes a single light guide element 24. The light guide element 24 includes a body 26 having a first end 28 and a second end 30 and is defined by two spaced surfaces 32, 34 extending from the first end 28 to the second end 30. As shown, the two spaced surfaces 32, 34 of the body 26 are substantially planar with one another. However, it should be noted that the body 26 may have a variety of different shapes and dimensions, as described in greater detail herein.

As previously described, the first end 28 of the body 26 is adapted collect the second portion of light emitted by the solid-state light source 14. It should be noted that the first end 28 of the body 26 may also be adapted to collect light reflected by the reflector 16 in addition to collecting the second portion of light emitted by the solid-state light source 14. In the illustrated embodiment, the first end 28 has an input surface 36 defining a generally concave shape adapted to improve light collection efficiency. For example, the concave shape of the input surface 36 increases the overall area of the first end 28 exposed to the second portion of light emitted by the solid-state light source 14, thereby increasing the collection efficiency of the first end 28 and input surface 36.

As shown, the second end 30 of the body 26 has an output surface 38 defining a plurality of discrete optic elements 40. As described in greater detail herein, each optic element 40 is configured to redirect light collected by the first end 28 in a particular direction. In most instances, in an effort to reduce the potential for glare, each optic element 40 configured to redirect light generally below the horizontal plane P_{H} extending through the body 26 of the light guide element 24 (shown in FIGS. 7A and 7B, for example).

FIGS. 7A and 7B illustrate enlarged side views of embodiments of optic elements 40 of the light guide assembly 22 of FIG. 6. As shown, each optic element 40 has a first surface 42 extending away from the second end 30 of the body 26 and a second surface 44 extending away from the second end 30 of the body 26 and intersecting with the first surface 42. The first and second surfaces 42, 44 define an included angle θ. The included angle θ defined by the first and second surfaces 42, 44 may include an acute angle, an obtuse angle, as well as a right angle.

As previously described, upon collecting the second portion of light emitted by the solid-state light source 14, the body 26 of the light guide element is adapted to transmit the collected second portion of light 46 from the first end 28 to the second end 30. As shown, upon entering the input surface 36 of the first end 28 of the body 26, the collected second portion of light 46 proceeds through the body 26 until the light 46 reaches the output surface 38 of the second end 30 of the body 26. As generally understood, the body 26 may include any known or later discovered material adapted to provide optical transmission of light. In one embodiment, the body 26 may include a thermoplastic polymer, such as, for example, a polycarbonate resin. At the output surface 38, each optic element 40 defined thereon is adapted to redirect the collected second portion of light 46 generally in a direction to prevent glare, such as, for example, in a downward direction toward a foreground in front of the headlamp 10 and vehicle.

Referring to FIG. 7A, one embodiment of an optic element 40 is illustrated. As shown, upon receiving the collected second portion of light 46, the first surface 42 of the optic element 40 is adapted to refract, indicated by arrow 48, the collected second portion of light 46 in a direction away from the output surface 38 and second end 30 of the body 26 and generally below the horizontal plane P_{H} extending through the body 26 of the light guide element 24, thereby resulting in refracted light 50 emitted from the headlamp 10.

In some embodiments, the body 26 of the light guide element 24 may shaped, sized and/or be composed of a material allowing internal reflection of light. For example, as shown in FIG. 7B, the material of which the light guide body 26 is composed may allow internal reflection of the collected second portion of light 46, as indicated by arrow 52. In the illustrated embodiment, the body 26 is adapted to internally reflect the collected second portion of light 46 in a direction away from the first end 28 and towards the second end 30 of the body 26. Upon receiving the reflected collected second portion of light 46, the first surface 42 of the optic element 40 is adapted to refract, indicated by arrow 48, the collected second portion of light 46 in a direction away from the output surface 38 and second end 30 of the body 26 and generally below the horizontal plane P_{H} extending through the body 26 of the light guide element 24, thereby resulting in refracted light 54 emitted from the headlamp 10.

As generally understood, the angle at which the light 50, 54 of FIGS. 7A and 7B is refracted may be dependent at least upon the index of refraction of the material of which the light guide element 24 is composed relative to that of the material surrounding the light guide element 24 (e.g., but not limited to, air).

FIGS. 8A and 8B illustrate top cross-sectional and side views, respectively, of the headlamp 10 of FIG. 1 with the reflector 16 adapted to provide a low-beam illumination pattern. In the illustrated embodiment, the headlamp 10 includes a housing 56 shaped and/or sized to receive and enclose the reflector 16, light guide assembly 22 and at least a portion of the light engine 12 within. Optionally, the headlamp 10 also includes an outer lens 58 coupled to at least a portion of the housing 56. The outer lens 58 may be provided to increase the aerodynamics of the headlamp 10. For example, the outer lens 58 may allow the headlamp 10 to aerodynamically blend in with the adjacent portions of the vehicle to reduce aerodynamic drag. The outer lens 58 may also be configured to protect components of the headlamp 10, including, but not limited to, the light engine 12, the reflector 16 and the light guide assembly 22. The outer lens 58 may further be configured to emit visible light reflected by the reflector 16 and/or redirected and emitted by the light guide assembly 22 in one or more distribution patterns. For example, the outer lens 58 may be configured to further aid in the distribution of the visible light emitted from the headlamp 10 in the low-beam mode and/or high-beam mode.

As shown in FIGS. 8A and 8B, at least a portion of the light engine 12 is positioned within the reflector 16. The solid-state light source 14 has an emission axis X around which an emission pattern of the emitted light is centered. As shown, the emission axis X is oriented in a direction towards the reflective surface 20 of the light collecting region 18 of the reflector 16. The solid-state light source 14 is adapted to emit a first portion of light (e.g., illustrated schematically as light beam B₁) in a direction towards the reflective surface 20 of the light collecting region 18 of the reflector 16. In turn, the reflective surface 20 is adapted to redirect (e.g., reflect), as indicated by arrow 60, the first portion of visible light from the solid-state light source 14 toward an open end 62 of the reflector 16, such that the visible light B₁ is projected from the headlamp 10 in the first illumination pattern (shown as a low-beam illumination pattern), generally below or at and below the horizontal plane P_{H}.

The solid-state light source 14 is further adapted to emit a second portion of light (e.g., illustrated schematically as light beams B₂, B₃, Bₙ) in a direction towards the light guide assembly 22, specifically towards the first end 28 of the light guide body 26. As previously described, the second portion of light may generally include stray light, wherein, if allowed to emit from the headlamp 10, the stray light may result in glare that can distract and temporality affect the vision of oncoming drivers. In turn, the input surface 36 surface of the first end 28 is adapted to collect, as indicated by arrow 64, the second portion of visible light from the solid-state light source 14. It should be noted that the input surface 36 may also be adapted to collected light reflected from the reflector 16 that would otherwise be stray light. The collected second portion of light is then transmitted from the first end 28 to the second end 30 of the body 26. As shown, the collected second portion of light may propagate, as indicated by arrow 66, through the body 26. In some instances, the material of which the light guide body 26 is composed may allow internal reflection, as indicated by arrow 68, of the collected second portion of light. Upon reaching the second end 30, the collected second portion of light is redirected, as indicated by arrow 70, by the one or more optic elements 40 defined on the output surface 38 of the second end 30.

As shown, the optical elements 40 are adapted to redirect the collected second portion of visible light toward the open end 62 of the reflector 16, such that the visible light B₂, B₃, Bₙ is projected from the headlamp 10 in the second illumination pattern, generally below the horizontal plane P_{H}. In the illustrated embodiment, each optical element 40 is shown to be redirecting the collected second portion of light with a similar angle as other optical elements 40. It should be noted that the output surface 38 may include a combination of optical elements 40, wherein some of the optical elements 40 may have different associated refractive indexes, such that some of the optical elements 40 are adapted to redirect the collected second portion of light in different angles with respect to the horizontal plane P_{H}.

As used herein, the phrase “below the horizontal plane P_{H}” means the visible light emitted from the headlamp 10 is emitted generally downwardly from the headlamp 10 and towards the ground and the phrase “at and below the horizontal plane P_{H}” means the visible light emitted from the headlamp 10 is emitted generally parallel to ground and/or downwardly from the headlamp 10 and towards the ground, referenced to a condition where the headlamp 10 is mounted in the vehicle.

A headlamp including a light guide assembly consistent with the present disclosure was simulated for output performance (luminous flux). Simulations were performed using ASAP® (Advanced System Analysis Program) optical engineering and design software offered by Breault Research Organization (Tucson, Ariz.). The headlamp included a light engine sold under the trade designation JOULE JFL2, including a 5 chip LED array having a total flux of 1000 lm. The headlamp further included a reflector having the following dimensions: 93 mm height; 100 mm width; and approximately 70 mm depth. The distance from the center of the LED array of the light engine was approximately 28 mm. The light guide assembly included at least one light guide element having a width of 5 mm, and the first end having a height of approximately 7 mm and the second end having a height of approximately 60 mm. Simulations were performed on a headlamp without a light guide assembly and including a conventional fixed glare baffle and a headlamp having a light guide assembly having a single light guide element having a substantially planar shape (i.e., the two spaced surfaces 32, 34 of the body were substantially planar).

Upon simulation, it was found that the headlamp without the light guide assembly produces a luminous flux of approximately 541 lm in the beam, produced by the reflector. It was found that the headlamp with the light guide assembly produces a luminous flux of approximately 625 lm, wherein the light guide assembly was found to collect approximately 150 lm, of which, approximately 80 lm were redirected and combined with the output of the reflector. Accordingly, a light guides consistent with the present disclosure increases the overall performance of the headlamp.

FIGS. 9 and 10 illustrate perspective views of other embodiments a light guide assemblies 22a, 22b, respectively, of a headlamp 10 consistent with the present disclosure. Referring to FIG. 9, the light guide assembly 22a includes multiple light guide elements. As shown, the light guide assembly 22a includes three light guide elements 24a, 24b, 24c coupled to one another. As shown, the light guide elements 24a-24c are substantially identical to one another in both shape and dimensions, and may therefore provide substantially similar performance. It should be noted, however, that the light guide elements 24a-24c may differ from one another. The inclusion of multiple light guide elements may increase the collection efficiency of stray light, thereby improving performance of the headlamp.

As shown, in FIG. 10, the light guide assembly 22b includes multiple light guide elements 24a-24c coupled to one another. FIG. 11 illustrates a top view of the light guide assembly 22b and headlamp 10 of FIG. 10. In this embodiment, some of the light guide elements may be different from one another. As shown, light guide elements 24a and 24b have a different shape than light guide element 24c. For example, the first light guide element 24a includes a body 26 defined by two spaced surfaces 32, 34, wherein at least one of the surfaces 32, 34 is generally arcuate along the horizontal plane P_{H} extending through the body 26. As such, the first light guide element 24a may have curved shape. The second light guide element 24b is also shown as having a curved shaped, although the curve is less dramatic than the curved shape of the first light guide element 24a. The third light guide element 24c has a substantially planar shape. Having one or more generally curved or bent light guide elements, as shown in FIGS. 10 and 11, may result in the redirection of stray light around the corner of the vehicle, for example. Additionally, curved light guide elements may provide a more interesting design and look to the headlamp 10.

It should be noted that the low and high-beam patterns projected from the headlamp 10 conform to current U.S. Department of Transportation (DOT) Federal Motor Vehicle Safety Standards (FMVSS) 108 specifications for the low and high-beam output of a vehicle headlamp. It should be noted that the low and high-beam patterns projected from the headlamp 10 may also conform to current international ECE Regulations specifications for the low and high-beam output of a vehicle headlamp.

In the illustrated embodiments described herein, reflective surface 20 of the reflector 16 is shaped and/or sized to reflect visible light from the solid-state light source 14 out of the reflector 16 in a low-beam illumination pattern, generally below or at and below the horizontal plane P_{H} and not above the horizontal plane P_{H}. In other embodiments, the reflective surface 20 of the reflector 16 may be shaped and/or sized to reflect visible light from the solid-state light source 14 out of the reflector 16 in a high-beam illumination pattern, generally above and below the horizontal plane P_{H} and the second solid-state light source 46 is configured to emit visible light out of the reflector 26 below or at and below the horizontal plane P_{H} and not above the horizontal plane P_{H}. The light guide assembly 22 is generally adapted to redirect stray light emitted by the solid-state light source 14 and/or reflected by the reflector 16 generally below the horizontal plane and not above the horizontal plane P_{H} so as to reduce the potential for glare caused by the stray light.

As such, a headlamp consistent with the present disclosure does not require fixed glare baffle to aid in the blocking of stray light. Accordingly, a headlamp consistent with the present disclosure requires less components, which may reduce manufacturing costs. A light guide assembly consistent with the present disclosure is adapted to collect stray light that would otherwise be blocked by a fixed glare baffle, and further redirect the collected stray light in a desired illumination pattern, thereby utilizing the stray light in the output of the headlamp. Accordingly, a headlamp consistent with the present disclosure increases the overall collection efficiency of the headlamp and thereby improves overall performance and quality of light output of the headlamp.

The shape of the reflector 16 may include, but is not limited to, known parabolic, elliptical and sphero-elliptical configurations including those with faceted interior surfaces as well as truncated reflector cups. The phrase “truncated reflector cup” means a portion of a reflector cup, as may be realized, for example, by dividing a reflector cup along a plane intersecting the longitudinal axis (e.g., intersecting a first end and a second end). A truncated reflector may thus be configured as one-half of a reflector cup, but may be more or less than half of a reflector cup. For example, a truncated reflector cup may have a semi-parabaloid or semi-ellipsoid shape.

As generally understood by one of ordinary skill in the art, the reflective surface 20 of the reflector 26 may include parametric and/or non-parametric surface definition types including, but not limited to, non-uniform rational basis spline (NURBS) curves and/or surfaces configured to reflect the light received from the solid-state light source 14 in the desired pattern (i.e. low-beam and high-beam patterns). Commercially available software including, but not limited to, computer-aided design (CAD), computer-aided manufacturing (CAM), and computer-aided engineering (CAE) software, may be used for the design of NURBS curves and/or surfaces of the reflector 16. For example, a reflector consistent with the present disclosure may be designed using LucidShape computer-aided lighting software offered by Brandenburg GmbH (Paderborn, Germany).

The reflector 16 may be selected to have a high reflectivity. For example, the reflector 16 may have a reflectivity equal to or greater than 85%. According to one embodiment, the reflector 16 may include a metal (such as, but not limited to, aluminum, copper, silver, gold, or the like), metal alloys, plastics (e.g., but not limited to, doped plastics), as well as composites. It should be appreciated that the arrangement, shape and/or contour of the light engine 12, the reflector 16 and light guide assembly 22 will depend on the specific application of the headlamp 10 and may include (but is not limited to) such factors as the overall size constraints on the headlamp 10, desired aesthetic appearance of the headlamp 10, as well as the desired luminosity of the headlamp 10.

Accordingly, consistent with one embodiment of the present disclosure, an automotive headlamp 10 is provided. The automotive headlamp 10 includes a solid-state light source 14 and a reflector 16 having a light collecting region 18 adapted to receive a first portion of light emitted by the solid-state light source 14 and reflect the first portion of light in a first illumination pattern. The automotive headlamp 10 further includes a light guide assembly 22 adapted to receive a second portion of light emitted by the solid-state light source 14 and redirect the second portion of light in a second illumination pattern. The light guide assembly 22 includes at least one light guide element 24 includes a body 26 having a first end 28 and a second end 30 and being defined by two spaced surfaces 32, 34 extending from the first end 28 to the second end 30. The first end 28 is positioned adjacent to the solid-state light source 14 and adapted to collect the second portion of light. The body 26 is adapted to transmit the collected second portion of light from the first end 28 to the second end 30 and the second end 30 is adapted to redirect the collected second portion of light in the second illumination pattern.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals.

While the principles of the present disclosure have been described herein, it is to be understood by those skilled in the art that this description is made only by way of example and not as a limitation as to the scope of the disclosure. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

The following is a non-limiting list of reference numerals used in the specification:
10 headlamp
12 light engine
14 solid-state light source
16 reflector
18 light collecting region
20 reflective surface of light collecting region
22 light guide assembly
24 light guide element
26 body of light guide element
28 first end of body
30 second end of body
32 surface of body
34 surface of body
36 input surface of first end of body
38 output surface of second end of body
40 optic elements defined on output surface
42 first surface of optic element
44 second surface of optic elements
46 collected second portion of light
48 refraction of collected second portion of light
50 refracted light from first surface of optic element
52 internal reflection of collected second portion of light
54 refracted light from first surface of optic element
56 housing
58 outer lens
60 reflection of first portion of light from light collecting region
62 open end of reflector
64 collection of second portion of light
66 propagation of collected second portion of light within body of light guide element
68 reflection of propagated light
70 redirection of propagated light
θ included angle formed by first/second surfaces of optic element
B₁-Bₙ light beams
P_{H} horizontal plane
X emission axis of solid-state light source

What is claimed is:

1. An automotive headlamp (10) comprising:
a solid-state light source (14);
a reflector (16) having a light collecting region (18) adapted to receive a first portion of light emitted by said solid-state light source (14) and reflect said first portion of light in a first illumination pattern; and
a light guide assembly (22) adapted to receive a second portion of light emitted by said solid-state light source (14) and redirect said second portion of light in a second illumination pattern, said light guide assembly (22) comprising at least one light guide element (24) comprising a body (26) having a first end (28) and a second end (30) and being defined by two spaced surfaces (32, 34) extending from said first end (28) to said second end (30), said first end (28) being positioned adjacent to said solid-state light source (14) and adapted to collect said second portion of light, said body (26) being adapted to transmit said collected second portion of light from said first end (28) to said second end (30) and said second end (30) being adapted to redirect said collected second portion of light in said second illumination pattern;
wherein said first portion of light is emitted by said solid-state light source (14) in a direction towards said light collecting region (18) of said reflector (16) and said second portion of light is emitted by said solid-state light source (14) in a direction towards said first end (28) of said body (26) of said light guide element (24).

2. The automotive headlamp of claim 1, wherein said first end (28) of said body (26) of said light guide element (24) has an input surface (36) defining a generally concave shape adapted to improve light collection efficiency.

3. The automotive headlamp of claim 1, wherein said second end (30) of said body (26) of said light guide element (24) has an output surface (38) defining a plurality of discrete optic elements (40).

4. The automotive headlamp of claim 3, wherein each optic element (40) has a first surface (42) extending away from said second end (30) of said body (26) and a second surface (44) extending away from said second end (30) of said body (26) and intersecting with said first surface (42), said first and second surfaces (42, 44) defining an included angle (θ).

5. The automotive headlamp of claim 4, wherein said included angle (θ) defined by said first and second surfaces (42, 44) is selected from the group consisting of acute, obtuse and right.

6. The automotive headlamp of claim 4, wherein said first surface (42) is adapted to refract said collected second portion of light in a direction away from said second end (30) of said body (26) and generally below a horizontal plane (P_{H}) extending through said body (26) of said light guide element (24).

7. The automotive headlamp of claim 3, wherein said body is adapted to reflect said collected second portion of light in a direction away from said first end (28) and towards at least one of said plurality of optic elements (40).

8. The automotive headlamp of claim 1, wherein said two spaced surfaces (32, 34) of said body (26) are substantially planar with one another.

9. The automotive headlamp of claim 1, wherein at least one of said two spaced surfaces (32, 34) of said body (26) is generally arcuate along a horizontal plane (P_{H}) extending through said body (26) of said light guide element (24).

10. The automotive headlamp of claim 1, wherein said light guide assembly (22) further comprises at least one additional light guide element (24a, 24b, 24c) coupled to said at least one light guide element (24).

11. The automotive headlamp of claim 1, wherein said solid-state light source (14) comprises at least one light emitting diode (LED) light source.

12. The automotive headlamp of claim 1, wherein said second portion of light is emitted by said solid-state light source (14) in a direction away from said light collecting region (18) of said reflector (16).

13. The automotive headlamp of claim 1, wherein said first illumination pattern is selected from the group consisting of a low-beam illumination pattern and a high-beam illumination pattern.

14. The automotive headlamp of claim 13, wherein said low-beam illumination pattern comprises visible light emitted generally below or at and below a horizontal plane (P_{H}) and wherein said high-beam illumination pattern comprises visible light emitted generally above and below said horizontal plane (P_{H}).

15. The automotive headlamp of claim 1, wherein said second illumination pattern comprises visible light emitted generally below a horizontal plane (P_{H}) extending through said body (26) of said light guide element (24).
